(19) United States
(12) Patent Application Publication
(10) Pub. No.: US 2023/0036276 A1
(43) Pub. Date: Feb. 2, 2023

(54) ELECTRIC DRIVE SYSTEM FOR AN ENGINE

(71) Applicants: Transportation IP Holdings, LLC, Norwalk, CT (US); Komatsu America Corp., Chicago, IL (US); Cummins Inc., Columbus, IN (US)

(72) Inventors: Henry Todd Young, Erie, PA (US); Rekha Doddarangaiah Prasad, Warrendale, PA (US); Timothy Brown, Erie, PA (US); David John Scott, Washington, IL (US); Timothy Robert Heller, Germantown Hills, IL (US); Phanindra Garimella, Bloomington, IN (US)

(21) Appl. No.: 17/876,186

(22) Filed: Jul. 28, 2022

Related U.S. Application Data
(60) Provisional application No. 63/228,421, filed on Aug. 2, 2021.

(51) Int. Cl. B60W 30/188; B60W 10/06

(52) U.S. Cl. CPC B60W 30/188; B60W 10/06; B60W 2300/125; B60W 2530/10; B60W 2552/15; B60W 2710/0644; B60W 2510/0666

(57) ABSTRACT

A vehicle control system determines that a vehicle is not fully loaded with a payload, determines an upper limit on engine propulsion power for the vehicle that is not fully loaded with the payload, and reduces an engine speed of the vehicle to a determined speed at which a power capability of an engine of the vehicle matches the upper limit on the engine propulsion power of the vehicle.

### CROSS-REFERENCE TO RELATED APPLICATIONS

This application claims priority to U.S. Provisional Application No. 63/228,421 (filed 2 Aug. 2021), the entire disclosure of which is incorporated herein by reference.

### BACKGROUND

### Technical Field

The subject matter described herein relates to a vehicle propulsion system, such as an electric drive system and associated method.

### Discussion of Art

Vehicles carrying cargo can require varying power outputs to enable the vehicles to be propelled along routes. With respect to mining vehicles, many mining vehicles may be moving in a mine or other location at the same speed to ensure that the vehicles maintain duty haul cycles. The vehicles must maintain moving speed with the other vehicles even when fully loaded to avoid slowing down other vehicles in the mine. The vehicles must also be able to travel up inclines, and the like. Full power generation may consume more fuel than needed, especially when the vehicles are not fully loaded with cargo.

It may be desirable to have a system and method that differs from those that are currently available.

### BRIEF DESCRIPTION

In one example, a method (e.g., for controlling a vehicle) is provided. The method includes determining that a vehicle is not fully loaded with a payload, determining an upper limit on engine propulsion power for the vehicle that is not fully loaded with the payload, and reducing an engine speed of the vehicle to a determined speed at which a power capability of an engine of the vehicle matches the upper limit on the engine propulsion power of the vehicle.

In one example, a system (e.g., a vehicle control system) is provided and includes one or more processors that may determine that a vehicle is not fully loaded with a payload. The one or more processors also may determine an upper limit on engine propulsion power for the vehicle that is not fully loaded with the payload. The one or more processors also may reduce an engine speed of the vehicle to a determined speed at which the engine propulsion power of the engine matches the upper limit on the engine propulsion power for the vehicle that is not fully loaded with the payload.

In one example, a method (e.g., for controlling a vehicle) is provided and includes determining that a mining vehicle is empty of a payload, determining an upper limit on engine propulsion power for the vehicle that is empty of the payload, and reducing an engine speed of the vehicle to a determined speed at which a power capability of an engine of the mining vehicle matches the upper limit on the engine propulsion power of the mining vehicle.

### BRIEF DESCRIPTION OF THE DRAWINGS

The inventive subject matter may be understood from reading the following description of non-limiting embodiments, with reference to the attached drawings, wherein below:

FIG. 1 illustrates one example of an electric drive system;

FIG. 2 illustrates a flowchart of one example of a method for controlling a drive system of a powered system; and

FIG. 3 illustrates one example of a power output curve for the engine of the powered system shown in FIG. 1.

### DETAILED DESCRIPTION

Embodiments of the subject matter described herein relate to a propulsion system and method. The propulsion system may include an electric drive system, a controller, and/or an engine and the method may control operating settings at which the propulsion system operates. In one embodiment, the operating settings can be speeds of the engine. Alternatively, the operating settings can be an amount of fuel consumed by the engine, an amount of energy consumed (e.g., by the drive system), or the like. Optionally, the propulsion system is an electric propulsion system that does not include an engine, but that propels a vehicle by powering motors using electric energy. The propulsion system and method can operate as described herein to increase the efficiencies of the vehicle operation (e.g., by consuming less fuel, reducing electrical losses, reducing electric energy consumed, or enhancing performance or responsiveness).

In one embodiment, an electric drive system of a vehicle (e.g., a diesel electric haul truck, bus, automobile, agricultural vehicle, or another type of vehicle) can determine a cargo status of the vehicle. The cargo status is whether the vehicle is fully loaded with cargo, partially loaded with cargo, empty of cargo, the type of cargo, etc. The vehicle can operate in different modes depending on the cargo status. When the vehicle is operated while empty of cargo (e.g., cargo other than one or more operators onboard the vehicle and other components of the vehicle), the drive system control reduces an upper limit on the propulsion power of the engine to a lower level to reduce energy consumption (e.g., fuel and/or electric energy) while reducing or minimizing the impact to the haul cycle time (e.g., the time needed for the vehicle to haul cargo from a starting location to a delivery location and then back to the starting location or another location to pick up additional cargo). Prior to this reduction, the upper limit may be the maximum power that the propulsion system (e.g., the engine) is manufactured to produce or capable to produce at any operational setting (e.g., engine speed). At this new upper limit, power that has been reduced, the drive system can load the propulsion system to a torque curve to give increased or maximum energy efficiency. The reduced power and speed can be continuous or selected from a fixed set of energy-efficient operating points.

The power and setting adjustment can be achieved in different ways from embodiment to embodiment as described herein. As one example, the adjustment can be a fixed, pre-determined limit chosen based the vehicle application, including haul profile and duty cycle. Alternatively, the adjustment can be made dynamically based on factors such as vehicle speed, grade, acceleration, etc. Additionally, the drive system can determine when conditions are not favorable for empty vehicle operation (as described above), and change an operating state or mode of the vehicle back to a maximum or other upper limit of a propel power operating point. One such condition is grade, where the drive system uses an estimated or actual measured grade to change to max propel operating point when grade is above a specific threshold and re-enable when grade is below a second threshold. This can help achieve reduced fuel consumption without sacrificing productivity.

In operation, a drive system controller determines whether operating conditions are allowed for empty vehicle operation. When the vehicle is empty of cargo, a reduced maximum propulsion power limit and operating setting (e.g., engine speed, current load, etc.) for the vehicle can be determined. This propulsion power limit can be an amount of power required to propel the vehicle that is empty of cargo, which will be less than the maximum power that the propulsion system can operate when the vehicle is fully loaded with cargo. Optionally, this limit may be greater than the minimum amount of power required to propel the empty vehicle. For example, the limit may be 10% greater than this minimum amount to account for sudden acceleration of the vehicle by an operator. At the reduced power limit, the drive system can load the propulsion system up to a torque curve without needing additional headroom above the torque curve.

The power and operating setting can be recalculated for the entire operating range of the propulsion setting and the operating points chosen to achieve the best or improved fuel efficiency while still maintaining performance of the vehicle may be identified. These new operating setting and power points can be pre-determined based on a customer preferred haul profile, application duty cycle, and truck characteristics. Alternatively, the operating setting and power operating points can be dynamically adjusted based on the vehicle speed, grade, acceleration, target haul cycle time, targeted vehicle speed determined by a dispatch system, etc.

The drive system also can determine whether the conditions do not meet or satisfy criteria for this empty vehicle load control, such whether the actual or estimated grade of the route is steeper than a designated threshold, whether cargo has been loaded onto the vehicle, etc. The drive system can increase the power limit imposed on the propulsion system in response to determining that the conditions do not meet the criteria, and then subsequently reduce the limit when the conditions meet or satisfy the criteria (e.g., the grade is not steeper than the threshold).

In one embodiment, the drive system may have a local data collection system deployed that may use machine learning to enable derivation-based learning outcomes. The drive system may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

The drive system may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The drive system may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

The drive system can use this artificial intelligence or machine learning to receive input (e.g., different cargo statuses), use a model that associates different cargo statuses with different operating modes or settings to select a new or different operating mode or setting, and then provide an output (e.g., the new or different operating mode or setting). The drive system may receive additional input (e.g., new or different cargo statuses, operator input, or the like), that indicates whether the machine-selected operating mode or setting provided a desirable outcome or not. Based on this additional input, the drive system can change the model, such as by changing which operating mode or setting would be selected when a similar or identical operating characteristics are received the next time or iteration. The drive system can then use the changed or updated model again to select an operating mode or setting, receive feedback on the selected mode or setting, change or update the model again, etc., in additional iterations to repeatedly improve or change the model using artificial intelligence or machine learning.

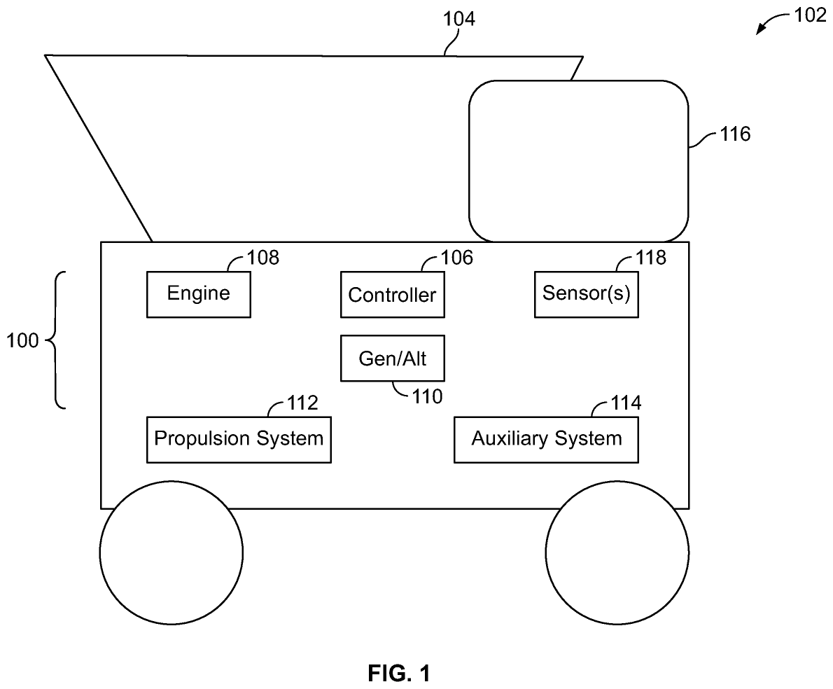

FIG. 1 illustrates one example of an electric drive system 100. The drive system is shown onboard a powered system 102, such as a mining vehicle (but alternatively can be a bus, automobile, rail vehicle, or the like). The illustrated powered system includes a hopper or other container 104 in which cargo can be carried by the powered system.

The drive system includes a controller 106 that represents hardware circuitry having and/or connected with one or more processors, such as one or more microprocessors, field programmable gate arrays, integrated circuits, and/or the like. The controller optionally can represent an engine control unit. In one embodiment, the controller communicates with an engine 108 of the powered system. This engine can be a fuel-consuming engine, such as a diesel engine. Not all embodiments of the inventive subject matter, however, are limited to diesel engines. The engine can represent another type of engine that consumes fuel other than diesel fuel.

The engine consume fuel to perform work, such as rotating a shaft joined to a generator or alternator 110 (“Gen/Alt” in FIG. 1), which causes the generator or alternator to output electric current. This current can be stored or provided to one or more powered components of the powered system, such as a propulsion system 112 and/or an auxiliary system 114. The propulsion system can represent one or more motors that propel the powered system (e.g., traction motors) using electric current output by the generator or alternator. Alternatively, the drive system may not include an engine, but the propulsion system may represent energy storage devices (e.g., batteries, capacitors, etc.) and traction motors that are powered by the energy storage devices. The auxiliary system can represent one or more other loads that consume at least some of this current, but not for propulsion of the powered system. For example, the auxiliary system can represent fans (e.g., blowers that cool parts of the propulsion system, blowers that cool braking resistors, pumps that force coolant to cool the engine or other components, etc.), heating and/or cooling systems that heat or cool an operator cab 116 of the powered system, or the like. Optionally, the propulsion system can represent a first group of one or more components that are powered by at least some of the current output by the generator or alternator and the auxiliary system can represent a separate, different second group of one or more components that also are powered by at least some of the current output by the generator or alternator.

One or more sensors 118 of the drive system sense characteristics of operation of the powered system and/or environment, and that output signals (e.g., wireless signals and/or signals that are conducted via one or more conductive pathways such as wires, cables, buses, etc.). As described herein, the controller can receive these characteristics to monitor the operation and/or environment of the powered system. Using this information, the controller can change (e.g., reduce) an upper limit on the amount of power that the engine and/or propulsion system is allowed to produce. This reduced upper limit may prevent the engine and/or propulsion system from producing more power than the reduced upper limit, even if the engine and/or propulsion system is capable of producing more power than the reduced upper limit in the absence of the limit being forced on the engine and/or propulsion system. The controller can then reduce the speed of the engine and/or the power output by the propulsion system to the speed or power output that corresponds to the reduced upper limit on the power capability of engine and/or propulsion system. The reduced speed of the propulsion system can be a speed at which a power capability of the propulsion system matches the reduced upper limit. The engine and/or propulsion system can then operate at this speed or power output (or within a tolerance, such as within 1%, 3%, or 5% in different embodiments). The number of each of the components shown in FIG. 1 is used as one example. For example, multiples of the engine, the controller, the sensor(s), the generator, the alternator, the propulsion system, and/or the auxiliary system may be provided.

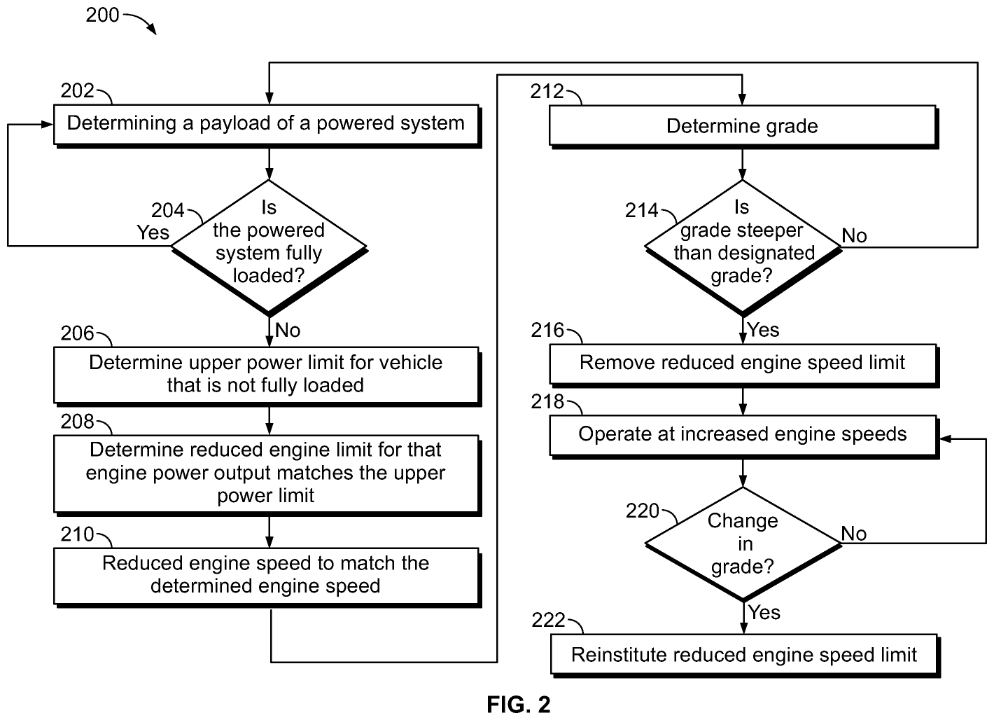

With continued reference to the drive system shown in FIG. 1, FIG. 2 illustrates a flowchart of one example of a method 200 for controlling a drive system of a powered system. The operations described in connection with the method can be performed by the controller unless otherwise described herein. At step 202, a payload being carried by the powered system is determined. For example, one or more of the sensors may be a weight scale, a camera, or the like, that output signals indicative of an amount of cargo being carried by the vehicle (e.g., in the vehicle container). The sensor(s) can send a signal to the controller that indicates a weight of the cargo in the container (if any), a signal that includes image data showing the amount of cargo in the container, etc.

At step 204, a determination is made as to whether the vehicle is fully loaded with cargo. The controller can receive the signal(s) sent by the sensor(s) and determine the amount of cargo carried by the vehicle (e.g., the payload of the vehicle). In one embodiment, the controller determines whether the vehicle is carrying at least a designated amount of cargo. For example, the controller can determine whether the vehicle is fully loaded with cargo (e.g., the container is full and cannot carry any more cargo, or the weight of the cargo is at a maximum or other upper limit). Alternatively, the controller can determine whether the vehicle is loaded with cargo at least a designated amount of cargo that is less than fully loaded.

If the vehicle is determined to be fully loaded with a payload of cargo, then the engine speed and/or power output of the propulsion system of the vehicle may not be able to be reduced. For example, several vehicles may be concurrently moving in a mine or other location, and may all move at a constant speed (e.g., within the tolerance described above) in a line or other arrangement. The speed of the fully loaded vehicle may not be able to be reduced as doing so would cause the vehicle to significantly slow down, thereby slowing down other vehicles trailing the fully loaded vehicle. As a result, the controller may continue operating the vehicle to allow the vehicle to operate at faster engine speeds and/or greater power outputs to keep up pace with the other vehicles. Flow of the method 200 can then return toward step 202 or terminate.

Alternatively, if the vehicle is determined to not be fully loaded with a payload of cargo, then an upper limit on the engine speed and/or power output of the vehicle may be able to be reduced. For example, the lighter payload carried by the vehicle can allow the engine speed and/or power output of the vehicle to be reduced (to no more than the reduced upper limit, as described herein), while the vehicle continues to travel at the same speed as the other vehicles (which may or may not be fully loaded with payloads) to avoid slowing down other vehicles behind the vehicle having the reduced upper limit on engine speed or power output, and/or to prevent this vehicle from running into another vehicle traveling ahead of the vehicle with the reduced upper limit on engine speed. Flow of the method can proceed toward step 206.

At step 206, an upper power limit is determined for the vehicle that is not fully loaded. For example, because the vehicle is not fully loaded with cargo, the vehicle may not require as much power (as a fully loaded vehicle) to move at the designated speed (e.g., thirty kilometers per hour or another speed) at which other vehicles are moving (or another designated or predetermined speed). The controller can determine an upper limit on the power output of the engine and/or the propulsion system that will allow the engine to power the propulsion system and/or for the propulsion system without the engine to move the vehicle at the designated speed, but no faster than the designated speed. Because the vehicle is not fully loaded, this upper limit may be lower than the maximum power that the engine and/or propulsion system is capable of producing (e.g., when the vehicle is fully loaded or loaded with more cargo).

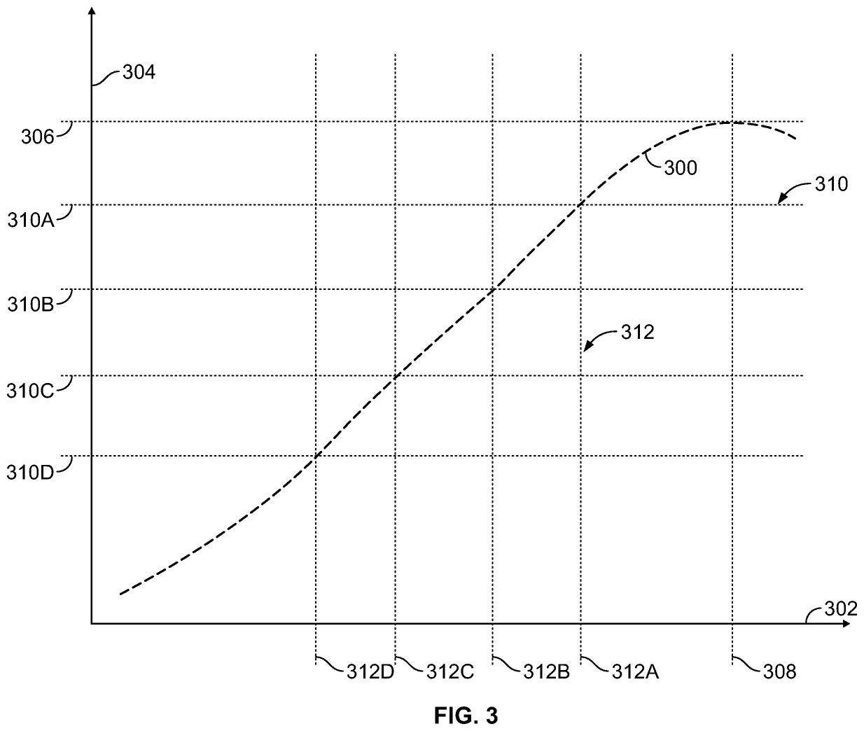

FIG. 3 illustrates one example of a power output curve 300 for the engine of the powered system shown in FIG. 1. The power output curve is shown alongside a horizontal axis 302 representative of different operating settings (e.g., engine speeds of the engine) and a vertical axis 304 representative of different powers output by the engine (at the corresponding engine speeds).

The controller can refer to the power output curve to determine a reduced upper limit on the power output of the engine. For example, a first upper limit 306 on the power output of the engine can represent the maximum power that the engine is capable of generating under any conditions. This can be the most power that the engine is manufactured to generate. The first upper limit is associated with a first engine speed 308. This is the engine speed at which the engine operates to move the vehicle (e.g., at the same speed of the other vehicles).

But, when the vehicle is not fully loaded with cargo, the vehicle may not require the engine to produce power at the first upper limit to travel at the same speed as other vehicles (e.g., in the mine). The controller can determine how much power output is required from the engine to propel the vehicle when not fully loaded with cargo (and maintain the same speed as when the vehicle is fully loaded and operating at the first engine speed 308). For example, the controller can store or access (in a tangible and non-transitory computer memory) different power outputs 310 (e.g., outputs 310A-D) of the engine with different amounts of cargo carried by the vehicle. While only four power outputs are shown in FIG. 3, the controller can store or access many more or fewer outputs.

These different power outputs can be associated with different engine characteristics, different vehicle characteristics, and/or different environmental characteristics. The engine characteristics can be relationships between different engine speeds and power outputs of the engine, as described below. The vehicle characteristics can include a weight of the vehicle. The environmental characteristics can include a grade on which the vehicle is located.

For example, the largest stored power output 310A can be associated with a heavier amount of cargo, heavier vehicle, and/or steeper grade than the outputs 310B-D (but a lighter amount of cargo, a lighter vehicle, and/or a less steep grade than the upper limit 306), the next largest stored power output 310B can be associated with heavier cargo, heavier vehicle, and/or steeper grade than the outputs 310C-D (but lighter cargo, lighter vehicle, and/or less steep grade than the output 310A and the upper limit 306), and so on. The controller can determine which of the power outputs provides at least enough power to propel the vehicle at the designated speed for the amount of cargo carried by the vehicle.

For example, if the vehicle is not fully loaded with cargo, but is carrying an amount of cargo that requires the engine to produce at least the power output 310B to move at the designated speed, then the controller can determine that the power output 310B is a new upper limit to be placed on the engine. If the vehicle is not fully loaded and is carrying even less cargo, the controller can determine that the engine needs to produce at least the power output 310C to move at the designated speed.

With continued reference to the power output curve shown in FIG. 3 but returning to the description of the method shown in FIG. 2, at step 208, the engine speed associated with the reduced power limit (that is determined at step 206) is determined. For example, the controller can refer to the power output curve and determine which engine speed is associated with the power limit. The different power outputs along the power output curve are associated with different engine speeds 312 (e.g., speeds 312A-D). If the controller determines that the reduced upper limit on the power output of the engine is at the power output 310B, then the controller can determine that the associated engine speed is at the speed 312B.

Alternatively, the controller can refer to a map (e.g., set) of operating points to determine the lower power output limit 310 and/or the associated engine speed 312. For example, different amounts (e.g., weights) of cargo can be associated with different power outputs and/or engine speeds in several sets of operating points. The controller can refer to the operating point having at least the amount of cargo carried by the vehicle (but less than another operating point), and obtain the power output and/or engine speed that is associated with this amount of cargo.

The power output that is determined can be referred to as the reduced upper limit on power output of the engine, and the associated engine speed can be referred to as a reduced upper limit on the speed of the engine. The reduced upper limit on the power output can be less than the maximum power that the engine is otherwise able to generate and the reduced upper limit on engine speed can be slower than the maximum speed at which the engine is otherwise able to operate.

At step 210 in the method shown in FIG. 2, the speed of the engine is reduced to the reduced upper limit on the speed of the engine. For example, if the vehicle is operating at a speed above the reduced upper limit 312B, then the controller can automatically control the engine to reduce the speed of the engine to no faster than the upper limit 312B. The controller can prevent the engine from operating at speeds faster than this upper limit by ignoring operating input or other changes that would otherwise increase the engine speed above the limit. The controller may allow the engine to operate at slower speeds, but prevents the engine from operating at faster speeds. Alternatively, the controller can allow the engine to only operate at the upper limit (within the tolerance described above), and not at faster or slower speeds.

In one embodiment, the reduced power output that is determined at step 206 can be the power output needed to propel the vehicle that is empty of cargo in the container or hopper at the designated speed. The controller can then determine the speed of the engine associated with this reduced power output, and set that determined speed to be the upper speed limit of the engine.

At step 212, a grade of the surface on which the vehicle is moving is determined. For example, one or more of the sensors can include an accelerometer that outputs information indicative of the grade of the route on which the vehicle is moving. Alternatively, different grades may be stored in a memory and associated with different locations. The controller can determine the location of the vehicle based on input from an operator, output from a sensor, such as a global positioning system receiver, a dead reckoning system, a wireless triangulation system, etc. The controller can then determine the grade from the memory based on the vehicle location.

At step 214, a determination is made as to whether the grade on which the vehicle is located is steeper than a designated threshold. For example, the controller can compare the grade determined at step 212 with a threshold to determine whether the vehicle is traveling up a steep grade (with the difference between a steep grade and a non-steep grade represented by the threshold, which can be an operator-selected value, a default value, or the like). If the grade exceeds the threshold, then this may indicate that the vehicle is traveling up a steep hill such that the reduced upper limit on engine power may prevent the engine from generating sufficient power to continue propelling the vehicle at least as fast as the designated speed, regardless of how much payload is carried by the vehicle (or regardless of no payload being carried by the vehicle). For example, the grade may be so steep that the vehicle cannot move up the grade or moves slower than the designated speed. As a result, flow of the method can proceed toward step 216.

But, if the grade does not exceed the threshold, then this may indicate that the vehicle is not traveling up a steep hill and the reduced upper limit on engine power may allow the engine to generate sufficient power to continue propelling the vehicle at least as fast as the designated speed. As a result, flow of the method can return toward step 202, return toward another operation, or may terminate.

At step 216, the reduced limit on the engine power and/or speed is eliminated or removed. The controller can increase the upper limit on the power that the engine can generate and permit the engine to operate at faster speeds. For example, if the controller determined that the upper limit on the engine power needed to be reduced from 306 to 310C (at 206) and the engine speed was reduced to 312C (at 208 and 210), then the controller may remove this limit so that the engine can operate at speeds faster than 312C.

At step 218, the vehicle is allowed to operate at engine speeds that exceed the engine speed associated with the reduced upper limit on engine power. The engine of the vehicle can operate at these increased speeds to permit the engine to generate sufficient power to move the vehicle up the grade at the designated speed (or faster).

At step 220, a determination is made as to whether the grade has changed. For example, the controller can determine whether the uphill grade on which the vehicle is moving is no longer steeper than the designated threshold. If the vehicle is no longer on a steep uphill grade (e.g., a grade that exceeds the threshold), then the controller may re-institute the reduced upper limit on engine power to increase fuel efficiency of the vehicle without causing the vehicle to move slower than the designated speed. Flow of the method can proceed toward 222. But, if the vehicle is still on a steep uphill grade (e.g., a grade that exceeds the threshold), then the controller may not re-institute the reduced upper limit on engine power so that the vehicle can continue moving up the steep grade without moving slower than the designated speed. Flow of the method can return toward 218.

At step 222, the reduced upper limit on engine power output (determined at 206) may be re-instituted. The controller may again reduce the maximum amount of power that the engine is allowed to generate (e.g., to the limit determined at 206) and may force the engine to operate at speeds that are no faster than this reduced upper limit on engine power, as described above. Flow of the method can then return toward one or more prior operations, such as 202, 206, 212, or may terminate.

In one example, a method (e.g., for controlling a vehicle) is provided. The method includes determining that a vehicle is not fully loaded with a payload, determining an upper limit on engine propulsion power for the vehicle that is not fully loaded with the payload, and reducing an engine speed of the vehicle to a determined speed at which a power capability of an engine of the vehicle matches the upper limit on the engine propulsion power of the vehicle.

The method also may include determining the engine speed that is reduced based on a predefined relationship between different values of the engine speed and different values of the engine propulsion powers. The method also can include determining whether a grade on which the vehicle is located is steeper than a designated grade threshold, and responsive to determining that the grade is steeper than the designated grade threshold, increasing or removing the upper limit on the engine propulsion power that can be generated by the engine. The method also can include determining whether the grade on which the vehicle is located is no steeper than the designated grade threshold and, responsive to determining that the grade is no steeper than the designated grade threshold, reinstituting the upper limit on the engine propulsion power that can be generated by the engine.

The upper limit on the engine propulsion power can be less than a maximum propulsion power capability of the engine. The upper limit on the engine propulsion power can be reduced by a reduction amount that is based on one or more of an engine characteristic or a vehicle characteristic. The engine characteristic can be a relationship between values of the engine speeds and values of the engine propulsion powers output by the engine. The vehicle characteristic can be a weight of the vehicle.

In one example, a system (e.g., a vehicle control system) is provided and includes one or more processors that may determine that a vehicle is not fully loaded with a payload. The one or more processors also may determine an upper limit on engine propulsion power for the vehicle that is not fully loaded with the payload. The one or more processors also may reduce an engine speed of the vehicle to a determined speed at which the engine propulsion power of the engine matches the upper limit on the engine propulsion power for the vehicle that is not fully loaded with the payload.

The one or more processors may determine the engine speed that is reduced based on a predefined relationship between different values of the engine speed and different values of the engine propulsion powers. The one or more processors may determine whether a grade on which the vehicle is located is steeper than a designated grade threshold. The one or more processors may increase or remove the upper limit on the engine propulsion power that can be generated by the engine responsive to determining that the grade is steeper than the designated grade threshold.

The one or more processors may determine whether the grade on which the vehicle is located is no steeper than the designated grade threshold. The one or more processors may re-institute the upper limit on the engine propulsion power that can be generated by the engine responsive to determining that the grade is no steeper than the designated grade threshold.

The upper limit on the engine propulsion power can be less than a maximum propulsion power capability of the engine. The one or more processors may reduce the upper limit on the engine propulsion power by a reduction amount that is based on one or more of an engine characteristic or a vehicle characteristic. The engine characteristic can be a relationship between values of the engine speeds and values of the engine propulsion powers output by the engine. The vehicle characteristic can be a weight of the vehicle.

In one example, a method (e.g., for controlling a vehicle) is provided and includes determining that a mining vehicle is empty of a payload, determining an upper limit on engine propulsion power for the vehicle that is empty of the payload, and reducing an engine speed of the vehicle to a determined speed at which a power capability of an engine of the mining vehicle matches the upper limit on the engine propulsion power of the mining vehicle.

The method also can include determining the engine speed that is reduced based on a predefined relationship between different values of the engine speed and different values of the engine propulsion powers. The method also can include determining whether a grade on which the vehicle is located is steeper than a designated grade threshold and increasing or removing the upper limit on the engine propulsion power that can be generated by the engine responsive to determining that the grade is steeper than the designated grade threshold. The method also can include determining whether the grade on which the vehicle is located is no steeper than the designated grade threshold, and reinstituting the upper limit on the engine propulsion power that can be generated by the engine responsive to determining that the grade is no steeper than the designated grade threshold.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
determining that a vehicle is not fully loaded with a payload;
determining an upper limit on engine propulsion power for the vehicle that is not fully loaded with the payload; and
reducing an engine speed of the vehicle to a determined speed at which a power capability of an engine of the vehicle matches the upper limit on the engine propulsion power of the vehicle.

2. The method of claim 1, further comprising:
determining the engine speed that is reduced based on a predefined relationship between different values of the engine speed and different values of the engine propulsion power.

3. The method of claim 1, further comprising:
determining whether a grade on which the vehicle is located is steeper than a designated grade threshold; and
responsive to determining that the grade is steeper than the designated grade threshold, increasing or removing the upper limit on the engine propulsion power that can be generated by the engine.

4. The method of claim 3, further comprising:
determining whether the grade on which the vehicle is located is no steeper than the designated grade threshold; and
responsive to determining that the grade is no steeper than the designated grade threshold, reinstituting the upper limit on the engine propulsion power that can be generated by the engine.

5. The method of claim 1, wherein the upper limit on the engine propulsion power is less than a maximum propulsion power capability of the engine.

6. The method of claim 1, wherein the upper limit on the engine propulsion power is reduced by a reduction amount that is based on one or more of an engine characteristic or a vehicle characteristic.

7. The method of claim 6, wherein the engine characteristic is a relationship between values of the engine speed and values of the engine propulsion power that is output by the engine.

8. The method of claim 6, wherein the vehicle characteristic is a weight of the vehicle.

9. A system comprising:
one or more processors configured to determine that a vehicle is not fully loaded with a payload, the one or more processors also configured to determine an upper limit on engine propulsion power for the vehicle that is not fully loaded with the payload, the one or more processors also configured to reduce an engine speed of the vehicle to a determined speed at which the engine propulsion power of an engine matches the upper limit on the engine propulsion power for the vehicle that is not fully loaded with the payload.

10. The system of claim 9, wherein the one or more processors are configured to determine the engine speed that is reduced based on a predefined relationship between different values of the engine speed and different values of the engine propulsion power.

11. The system of claim 9, wherein the one or more processors are configured to determine whether a grade on which the vehicle is located is steeper than a designated grade threshold and, responsive to determining that the grade is steeper than the designated grade threshold, the one or more processors are configured to increase or remove the upper limit on the engine propulsion power that can be generated by the engine.

12. The system of claim 11, wherein the one or more processors are configured to determine whether the grade on which the vehicle is located is no steeper than the designated grade threshold and, responsive to determining that the grade is no steeper than the designated grade threshold, the one or more processors are configured to re-institute the upper limit on the engine propulsion power that can be generated by the engine.

13. The system of claim 9, wherein the upper limit on the engine propulsion power is less than a maximum propulsion power capability of the engine.

14. The system of claim 9, wherein the one or more processors are configured to reduce the upper limit on the engine propulsion power by a reduction amount that is based on one or more of an engine characteristic or a vehicle characteristic.

15. The system of claim 14, wherein the engine characteristic is a relationship between values of the engine speed and values of the engine propulsion power that is output by the engine.

16. The system of claim 14, wherein the vehicle characteristic is a weight of the vehicle.

17. A method comprising:
determining that a mining vehicle is empty of a payload;
determining an upper limit on engine propulsion power for the vehicle that is empty of the payload; and
reducing an engine speed of the vehicle to a determined speed at which a power capability of an engine of the mining vehicle matches the upper limit on the engine propulsion power of the mining vehicle.

18. The method of claim 17, further comprising:
determining the engine speed that is reduced based on a predefined relationship between different values of the engine speed and different values of the engine propulsion power.

19. The method of claim 17, further comprising:
determining whether a grade on which the vehicle is located is steeper than a designated grade threshold; and
responsive to determining that the grade is steeper than the designated grade threshold, increasing or removing the upper limit on the engine propulsion power that can be generated by the engine.

20. The method of claim 19, further comprising:
determining whether the grade on which the vehicle is located is no steeper than the designated grade threshold; and
responsive to determining that the grade is no steeper than the designated grade threshold, reinstituting the upper limit on the engine propulsion power that can be generated by the engine.
